(19) United States
(12) Patent Application Publication
(10) Pub. No.: US 2009/0027032 A1
(43) Pub. Date: Jan. 29, 2009

(54) Circuit arrangment for the temperature-dependent regulation of a load current

(76) Inventor: Klaus Zametzky, Schwabach (DE)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 12/220,100

(22) Filed: Jul. 22, 2008

(30) Foreign Application Priority Data
Jul. 27, 2007 (DE) 10 2007 035 369.5

(51) Int. Cl. G05F 3/16

(52) U.S. Cl. 323/316

(57) ABSTRACT

The invention concerns a circuit arrangement (2) for the regulation of a current (I_{L}) through a load (R_{L}), with: a resistance (R_{S}), through which a load current (I_{L}) flows and across which a voltage (V_{S}) drops, which serves as a control variable for the regulation of the load current (I_{L}), a tapping point (P) for a reference voltage (V_{ref}), which serves as a command variable for the regulation of the load current (I_{L}), and a differential amplifier for the amplification of the control deviation (V_{ref}−V_{S}). The differential amplifier has a first and a second transistor (Q1, Q2) for the regulation of the load current (I_{L}) as a function of the temperature, and the circuit arrangement (2) is designed for the operation of the two transistors (Q1, Q2) at the same collector-emitter voltage (U_{CE1}, U_{CE2}) and at a constant ratio of the collector quiescent currents (I_{C1}, I_{C2}) being different from one, such that the circuit arrangement (2), controlled by temperature voltage as determined by the physics of semiconductors, regulates the load current (I_{L}) as a function of the temperature in a defined manner. The invention concerns moreover a motor vehicle fan with such a circuit arrangement (2) and an associated method.

The invention concerns a circuit arrangement for the temperature-dependent regulation of a current by a load with: a resistance, through which a load current flows and across which a voltage drops, which serves as a control variable for the regulation of the load current, a tapping point for a reference voltage, which serves as a command variable for the regulation of the load current, and a differential amplifier for the amplification of the control deviation. The invention furthermore concerns a motor vehicle fan with such a circuit arrangement, as well as a related method for the temperature-dependent regulation of a current through a load by means of a voltage drop across a resistance through which the load current flows as a control variable for the regulation of the load current, as well as by means of a reference voltage as the command variable for the regulation of the load current, wherein the control deviation is amplified in a differential amplifier.

The circuit arrangement described above can in general find application as a protective circuit, or also in control engineering, in particular in the regulation of a motor vehicle air conditioning system. A temperature-dependent regulation of the load current is in particular beneficial if the power consumption through the load resistance is not constant, but is e.g. a function of the ambient temperature. This is the case for a fan motor of a motor vehicle fan, in particular because hot air provides a higher flow resistance for the fan motor than cold air, due to the more rapid movement of the air molecules, since in a given period of time and spatial volume statistically there are more frequent collision events between molecules in hot air than in cold air. In an analogous manner to the electron gas in a metallic conductor, in which the mobility of the electrons reduces with temperature, and the electrical resistance rises, the flow resistance of the air flow in an HVAC (Heating, Ventilation and Air Conditioning) system also therefore rises with the gas temperature. If the air flows more slowly the fan motor draws less current than at a high air flow velocity. Many air conditioning systems therefore have the property of drawing more current at a given motor voltage under cold conditions than under hot conditions. The motor current draw therefore reduces with increasing temperature.

FIG. 1 shows a circuit arrangement 1 known in the art for the temperature-dependent regulation of a load current I_{L} through a load resistance R_{L}. To this end a current source I_{ref} (for the simplification of the representation no difference is made in what follows between resistances, voltage and current sources as components and the resistances, voltages and currents that are generated by them) feeds a temperature-dependent resistance R_{T}, which serves as a temperature sensor. Temperature-dependent resistances of this type as a rule have a (more or less) non-linear characteristic as a function of the temperature. The voltage drop across the temperature-dependent resistance R_{T} is therefore supplied firstly to a linearisation network LIN. A first operational amplifier OP1, placed in the circuit as a differential amplifier with a further resistance R1 between inverting input and output, subtracts the linearised signal from a reference voltage V_{ref} supplied to the first operational amplifier OP1 at a point P in the circuit (tapping point). A following second operational amplifier OP2 undertakes the actual current regulation, in that it compares a voltage drop V_{S} across a shunt resistance R_{S} through which the load current I_{L} flows with the output voltage of the first operational amplifier OP1 and constantly corrects the control voltage on the gate of the power transistor M1 (MOS-FET) serving as an actuating element. A voltage source V_{b} serves to supply the components of the circuit arrangement 1 with a battery voltage of V_{b}=12 V typical for motor vehicle electronics. The circuit arrangement 1 can regulate the load current I_{L}, for example on a fan motor as load, linearly as a function of the (ambient) temperature, wherein the load current can be e.g. 10 A at room temperature, and can reduce with rising temperature and/or increase with falling temperature.

If the circuit arrangement 1 must function stably over a wide temperature range between −30° C. und 150° C., as is common in motor vehicle applications, then the financial expenditure in its manufacture is not inconsiderable, since in this case, amongst others, high requirements are placed on the accuracy of the temperature sensor R_{T}, the reference sources I_{ref} and V_{ref}, the linearising network LIN, and on the two operational amplifiers OP1, OP2.

The object of the invention is to provide a cost-effective circuit arrangement, consisting of a small number of components, for the regulation, in particular linear regulation, of the current through a load, in particular through a fan motor, as a function of the temperature.

### SUMMARY OF THE INVENTION

This object is achieved by the circuit arrangement of the type cited in the introduction, in which the differential amplifier has a first and a second transistor for the regulation of the load current as a function of the temperature, wherein the circuit arrangement is designed for the operation of the two transistors at the same collector-emitter voltage and at a constant ratio of the collector quiescent currents being different from one.

The inventor has recognised that the regulation of the load current as a function of temperature can be implemented via a defined temperature behaviour of the circuit arrangement, that is to say, of individual components of this circuit arrangement, such that the use of a temperature sensor can be dispensed with. To this end the circuit arrangement has two (bipolar) transistors, whose temperature voltages as determined by the physics of semiconductors can be used in a defined manner as a control variable for the load current, wherein the temperature dependence of the load current regulation can be adjusted by the selection of the ratio of the collector currents. This ratio can be constant over the whole temperature range of the regulation, or can follow a prescribable temperature characteristic. Since with a current ratio of one the influence of the temperature voltages of the two transistors on the load current is exactly counterbalanced, it is necessary for the adjustment of a load current variable as a function of temperature to select a current ratio that is not equal to one.

If the ratio of the two collector quiescent currents is constant (and not equal to one), a temperature coefficient ensues that is constant and differs from zero, i.e. a linear relationship between load current and temperature. The temperature coefficient can hereby be defined as a function of the ratio of the collector currents to one another, both in magnitude and also in sign. Therefore the circuit arrangement can be dimensioned such that it allows higher currents at low temperatures and lower currents with increasing temperature, and thus adjusts itself to the temperature behaviour of the load, wherein the temperature behaviour of the circuit is achieved exclusively by component dimensioning. For the temperature control function no further components are therefore required.

In an advantageous embodiment the two transistors of the differential amplifier are base-coupled or emitter-coupled. By means of emitter coupling it is possible to achieve a high input resistance for the differential amplifier. A base coupling is also possible in the present circuit arrangement, since the shunt resistance through which the load current flows is of low resistance as a rule, and so a high input resistance is not absolutely necessary for the differential amplifier.

In a preferred embodiment for the generation of the same collector-emitter voltages the two transistors of the differential amplifier are embedded in a cascode structure with a third and a fourth transistor. The third or fourth transistor hereby forms respectively the base-coupled stage of the cascode circuit, while the first or second transistor forms respectively the emitter-coupled stage.

In a further advantageous embodiment the circuit arrangement has two resistances, whose resistance ratio defines the constant ratio of the collector quiescent currents. To this end the resistances can be connected with two further resistances to form a classic current mirror circuit. It is to be understood that other options for the generation of a constant ratio of the collector quiescent currents also exist, such as e.g. the provision of two constant current sources. The current mirror can also be generated if necessary by the adjustment of a suitable ratio of the active (emitter) surfaces of two transistors.

In a particularly advantageous embodiment the two transistors of the differential amplifier are formed by a dual transistor. The two transistors of a dual transistor are thermally coupled with one another and have the same or very similar electrical parameters, which is beneficial for an adjustment of the temperature dependence of the circuit arrangement in a defined manner.

In a further advantageous embodiment the circuit arrangement has a further transistor, preferably a power transistor, as an actuating element for the control circuit. Power transistors are used, for example, for the control of large currents, such as occur in fan motors of motor vehicles. The power transistor is preferably designed as a MOSFET, whereby the adjustment of the load current is made possible in a voltage-controlled manner, i.e. practically without a control current.

In a preferred embodiment the two transistors of the differential amplifier are thermally coupled with a further transistor. By means of the thermal coupling the transistors of the differential amplifier and the further transistor have the same temperature, so that the circuit arrangement regulates the load current as a function of the temperature of the further transistor and protects the latter from thermal overload.

In a further embodiment the two transistors of the differential amplifier are thermally coupled with the load, so that these have the same temperature. The load current is thus regulated as a function of the temperature of the load, as a result of which the latter can be protected from thermal overload.

In one embodiment the two transistors are thermally coupled with an ambient medium, in particular with an air flow of an air-conditioning system or a cooling fluid of a cooling water circuit, so that the load current can be regulated as a function of the temperature of the ambient medium.

It is particularly advantageous if the circuit arrangement is composed of discrete components. Since the circuit arrangement according to the invention comprises comparatively few components, it can be implemented in the form of discrete components cost-effectively. Such a circuit arrangement constructed from discrete components is robust, i.e. it can also be operated at high temperatures up to 150° C.

The invention is furthermore implemented in a motor vehicle fan with a circuit arrangement as described above, in which the load is formed by a fan motor. In this manner the desired, preferred linear dependence of the load current as a function of the temperature can be achieved.

The invention is further implemented in a method of the type cited in the introduction for the temperature-dependent regulation of the current through a load, in which for the regulation of the load current as a function of the temperature a first and second transistor of the differential amplifier are operated at the same collector-emitter voltage and at a constant ratio of the collector quiescent currents being different from one.

### BRIEF DESCRIPTION OF THE DRAWINGS

Examples of embodiments of the circuit arrangement according to the invention are represented in the schematic drawings and are elucidated in the following description. In the figures:

FIG. 1 shows a circuit diagram of a circuit arrangement for the temperature-dependent regulation of a load current according to the prior art,

FIG. 2 shows a first embodiment of a circuit arrangement according to the invention for the temperature-dependent load current regulation with two emitter-coupled transistors as a differential amplifier, and

FIG. 3 shows a second embodiment of a circuit arrangement according to the invention with two base-coupled transistors as a differential amplifier.

### DETAILED DESCRIPTION

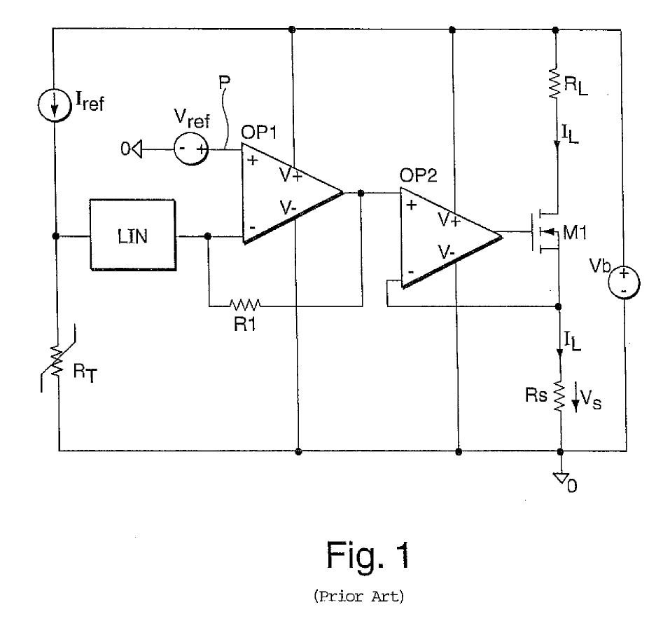

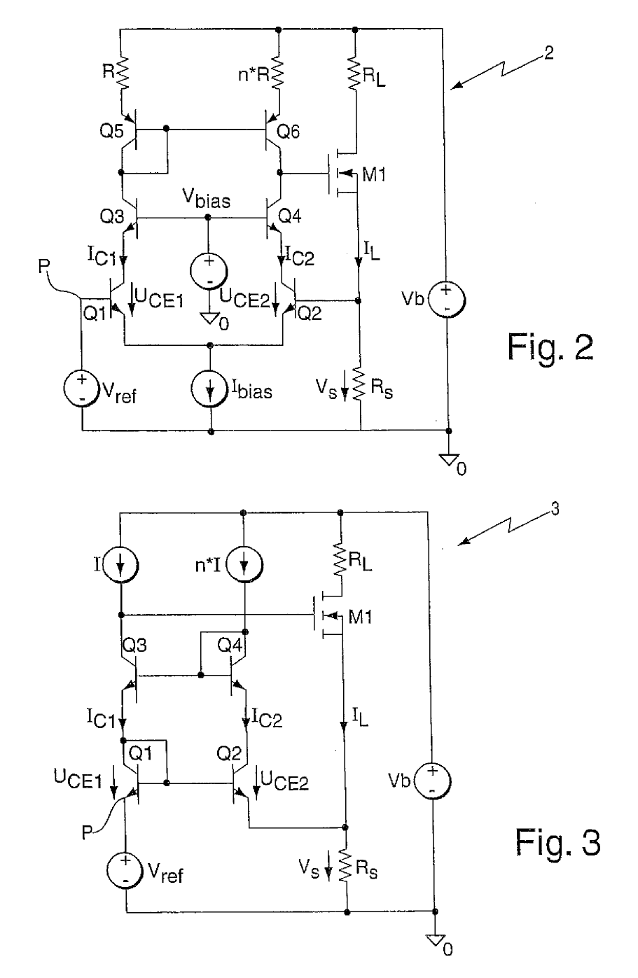

FIG. 2 shows a circuit arrangement 2 for the temperature-dependent regulation of the load current I_{L} through the load R_{L} of FIG. 1. To this end the circuit arrangement 2 has a tapping point P at the base of a first bipolar transistor Q1 for the reference voltage V_{ref}, which serves as a command variable for the regulation of the load current I_{L}. It is to be understood that if necessary the ground potential 0 can also be tapped as a reference voltage V_{ref}, so that in the circuit arrangement 2 no reference voltage source need be provided.

For the temperature-dependent load current regulation the circuit arrangement 2 has the shunt resistance R_{S}, described above in connection with FIG. 1, through which the load current I_{L} flows, and across which drops the voltage V_{S}, serving as a control variable for the regulation of the load current, and forming the base potential for a second bipolar transistor Q2. The first and the second transistors Q1, Q2 are emitter-coupled and form a differential amplifier for the amplification of the control deviation, i.e. the difference between the reference voltage V_{ref} and the voltage V_{S} across the shunt resistance R_{S}. The two transistors Q1, Q2 are designed as a dual transistor and therefore have almost identical thermal and electronic properties.

In order to enable a temperature-controlled regulation of the load current in a defined manner that is independent of the Early effect, the first and the second transistors Q1, Q2 are operated with the same collector-emitter voltage, i.e. U_{CE1}=U_{CE2}. This is enabled in that the first and second transistors Q1, Q2 in each case form a first, emitter-coupled stage of a cascode circuit, whose second, base-coupled stage is formed by a third and fourth transistor Q3, Q4. The bases of the third and fourth transistors lie at the same bias potential V_{bias}, and so in normal operation their emitters likewise lie at a correspondingly lower, identical potential, so that the collectors of the first and second transistors Q1, Q2 likewise have an identical potential. Furthermore, the emitters of the first and second transistors Q1, Q2 are connected with one another, and so overall an identical collector-emitter voltage U_{CE1}=U_{CE2} is set.

Moreover, for the generation of a defined linear temperature dependence of the load current I_{L} it is absolutely essential that the two transistors Q1, Q2 of the differential amplifier are operated with a constant ratio of the collector currents I_{C1} and I_{C2}, respectively. To this end the circuit arrangement 2 of FIG. 2 has a classic current mirror with two further resistances R and n*R, and also with a fifth and sixth transistor Q5, Q6. The base-collector section of the fifth transistor Q5 is hereby shunted out, as is usual with current mirrors, and a bias current source I_{bias} serves to provide the adjustment of the total current of the current mirror. The gate voltage for the power transistor M1 is tapped off from the collector of the sixth transistor Q6.

In what follows it is presented with the aid of analysis how with a prescribed ratio of the collector currents I_{C1} to I_{C2} and identical collector-emitter potentials U_{CE1}=U_{CE2} of the first and second transistors Q1, Q2 the desired linear dependence of the load current I_{L} on the temperature can be achieved. Here the details in brackets relate to the respective transistor Q1 or Q2.

According to Kirchhoff's rule the emitter potential of the two transistors Q1, Q2 is given by:

V_{ref}−U_{BE}(Q1)=I_{L}·R_{S}−U_{BE}(Q2)

For the load current I_{L} it thus ensues that:

$${I}_{L} = \frac{{V}_{ref} + {U}_{BE} ( Q 2 ) - {U}_{BE} ( Q 1 )}{{R}_{S}} . \qquad ( 1 )$$

Between the collector current I_{C} of a transistor, the base-emitter voltage U_{BE}, the collector-emitter voltage U_{CE}, the Early voltage U_{A}, the temperature voltage U_{T} and the inverse saturation current I_{S} there exists the following relationship, as known from the standard literature:

$${I}_{C} = {I}_{S} \cdot {e}^{\frac{{U}_{BE}}{{U}_{T}}} \cdot ( 1 + \frac{{U}_{CE}}{{U}_{A}} ) .$$

Solving for the base-emitter voltage U_{BE} gives:

$${U}_{BE} = {U}_{T} \cdot ln \frac{{I}_{C}}{{I}_{S} \cdot ( 1 + \frac{{U}_{CE}}{{U}_{A}} )} .$$

If the difference is formed between the base-emitter voltages of the two transistors Q1, Q2, then with the above equation one obtains:

$${U}_{BE} ( Q 2 ) - {U}_{BE} ( Q 1 ) = {U}_{T} \cdot ( ln \frac{{I}_{C} ( Q 2 )}{{I}_{S} ( Q 2 ) \cdot ( 1 + \frac{{U}_{CE} ( Q 2 )}{{U}_{A} ( Q 2 )} )} - ln \frac{{I}_{C} ( Q 1 )}{{I}_{S} ( Q 1 ) \cdot ( 1 + \frac{{U}_{CE} ( Q 1 )}{{U}_{A} ( Q 1 )} )} ) ,$$

which after transformation leads to the following equation:

$${U}_{BE} ( Q 2 ) - {U}_{BE} ( Q 1 ) = {U}_{T} \cdot ln \frac{{I}_{C} ( Q 2 ) \cdot {I}_{S} ( Q 1 ) \cdot ( 1 + \frac{{U}_{CE} ( Q 1 )}{{U}_{A} ( Q 1 )} )}{{I}_{C} ( Q 1 ) \cdot {I}_{S} ( Q 2 ) \cdot ( 1 + \frac{{U}_{CE} ( Q 2 )}{{U}_{A} ( Q 2 )} )} . \qquad ( 2 )$$

If one uses for the first and second transistors Q1, Q2 a dual transistor with paired properties as described above, then their inverse currents Is are similar, thus:

I_{S}(Q1)≈I_{S}(Q2).

Furthermore the third and fourth transistors Q3, Q4 act such that the first and second transistors Q1, Q2 have approximately the same collector potentials. Thus:

|U_{CE}(Q1)−U_{CE}(Q2)|<<U_{A}(Q1)≈U_{A}(Q2).

And thus equation (2) essentially simplifies to:

$${U}_{BE} ( Q 2 ) - {U}_{BE} ( Q 1 ) = {U}_{T} \cdot ln \frac{{I}_{C} ( Q 2 )}{{I}_{C} ( Q 1 )} .$$

Insertion of this equation into equation (1) for the load current I_{L} produces:

$${I}_{L} = \frac{{V}_{ref} + {U}_{T} \cdot ln \frac{{I}_{C} ( Q 2 )}{{I}_{C} ( Q 1 )}}{{R}_{S}} . \qquad ( 3 )$$

The temperature voltage UT can be traced back to physical constants and increases linearly with the temperature T, thus:

$${U}_{T} = \frac{k}{e} \cdot T = \frac{1 , 380662 \cdot {10}^{- 23} J}{1 , 6021892 \cdot {10}^{- 19} C} \cdot T = 86 , 17 \frac{μ V}{K} \cdot T . \qquad ( 4 )$$

What is noteworthy in the above analysis is that only the reference voltage V_{ref} and the ratio n of the two resistances R and n*R of the current mirror enter into the value of the load current I_{L}. The exact values of the bias voltage V_{bias} and the bias current I_{bias} do not play any part here. Therefore a high accuracy can be achieved with a comparatively small amount of effort. In addition to V_{ref} only the pairing tolerance of the first and second transistors Q1, Q2 as well as the resistances R, n*R of the current mirror, i.e. the factor n, enter into the load current I_{L}.

Since, as is well-known, it is essentially simpler and more cost-effective to achieve an accurate pairing tolerance between components than to implement components with a high absolute accuracy, it is possible to implement the above circuit arrangement 2 in a cost-effective manner, especially as it requires only a few components.

The temperature behaviour of I_{L} is obtained by inserting equation (4) for the temperature voltage UT into equation (3):

$${I}_{L} = \frac{{V}_{ref} + 86 , 17 \frac{μ V}{K} \cdot T \cdot ln \frac{{I}_{C} ( Q 2 )}{{I}_{C} ( Q 1 )}}{{R}_{s}} = \frac{{V}_{ref} + 86 , 17 \frac{μ V}{K} \cdot T \cdot ln \frac{1}{n}}{{R}_{s}} ,$$

and differentiating with respect to the absolute temperature:

$$\frac{d {I}_{L}}{d T} = \frac{86 , 17 \frac{μ V}{K} \cdot ln \frac{1}{n}}{{R}_{S}} .$$

The latter equation shows that a linear relationship exists between load current I_{L} and temperature T, as required. If the ratio n is selected to be equal to one, then the load current is independent of temperature, which can be advantageous in the case in which the current flow through a load should be constant over a wide range of temperature.

In addition to the circuit arrangement 2 shown in FIG. 2, which has a differential amplifier with emitter-coupled transistors Q1, Q2, this can also be implemented with base-coupled transistors Q1, Q2, as is represented in what follows with the aid of a circuit arrangement shown in FIG. 3.

In the circuit arrangement 3 of FIG. 3 the resistances of the current mirror are firstly replaced by two constant current sources I, n*I for the generation of the constant ratio of the two collector currents I_{C1}, I_{C2}, so that a bias current source can be dispensed with. As in FIG. 2 the third and fourth transistors Q3, Q4 serve to provide the setting of identical collector-emitter voltages U_{CE1}=U_{CE2} on the first and second transistors Q1, Q2. To this end the base-collector section of the first transistor Q1 and the base-collector section of the fourth transistor Q4 is in each case shunted out. From a network analysis according to Kirchhoff over the four transistors Q1 to Q4 it ensues, if one takes the Early voltage, which in commercial bipolar transistors amounts to approx. 30 V to 150 V, as an order of magnitude basis, that all base-emitter voltages in the circuit arrangement 3 are approximately identical. From this the required property of approximately identical collector-emitter voltages U_{CE1}=U_{CE2} on the first and second transistors Q1, Q2 immediately ensues.

From the analysis of the common base potential of the first and second transistors Q1, Q2 there follows equation (1), as specified above with reference to the circuit arrangement 2 of FIG. 2, for the load current I_{L}; so that the analyses made there also apply to the circuit arrangement 3. The load current I_{L} can therefore also be regulated linearly as a function of the temperature in the circuit arrangement 3 of FIG. 3.

The temperature regulation of the load current I_{L} with the circuit arrangements 2, 3 can take place as a function of the ambient temperature, if the two transistors Q1, Q2 of the differential amplifier used for temperature regulation are thermally coupled with an ambient medium, in particular with an air flow of an air-conditioning system or a cooling fluid of a cooling water circuit. Alternatively or additionally it is possible to couple thermally the two transistors with the load R_{L} or with the power transistor M1, in order to avoid any thermal overload of these components.

While the circuit arrangements 2, 3 shown in FIGS. 2 and 3 indeed have an essentially proportional or inversely proportional functional dependence of the load current I_{L} on the temperature T; it is to be understood that by suitable modification of the circuit arrangements 2, 3 almost any other functional dependencies of the form I_{L}=f(T) can also be set, as a result of which the circuit arrangements 2, 3 can be adapted to a large number of different types of load. In particular their range of application is therefore not restricted to the regulation of the load current of a fan motor in a motor vehicle fan.

What is claimed is:

1. A circuit arrangement (2, 3) for the regulation of a current (I_{L}) through a load (R_{L})), the arrangement comprising:
a resistance (R_{S}), through which a load current (I_{L}) flows and across which a voltage (V_{S}) drops, which serves as a control variable for the regulation of the load current (I_{L}),
a tapping point (P) for a reference voltage (V_{ref}), which serves as a command variable for the regulation of the load current (I_{L}), and
a differential amplifier for the amplification of the control deviation (V_{ref}−V_{S}), and
wherein
the differential amplifier has a first and a second transistor (Q1, Q2) for the regulation of the load current (I_{L}) as a function of the temperature, and wherein the circuit arrangement (2, 3) is designed for the operation of the two transistors (Q1, Q2) at the same collector-emitter voltage (U_{CE1}, U_{CE2}) and at a constant ratio of the collector quiescent currents (I_{C1}, I_{C2}) being different from one.

2. The circuit arrangement according to claim 1, wherein the two transistors (Q1, Q2) of the differential amplifier are base-coupled or emitter-coupled.

3. The circuit arrangement according to claim 1, wherein for the generation of the same collector-emitter voltages (U_{CE1}, U_{CE2}) the two transistors (Q1, Q2) of the differential amplifier are embedded in a cascode structure with a third and a fourth transistor (Q3, Q4).

4. The circuit arrangement according to claim 1 wherein further comprising two resistances (R, n*R), whose resistance ratio defining the constant ratio of the collector quiescent currents (I_{C1}, I_{C2}).

5. The circuit arrangement according to claim 1 wherein the two transistors (Q1, Q2) of the differential amplifier are formed by a dual transistor.

6. The circuit arrangement according to claim 1 further comprising a power transistor (M1) as an actuating element for the control circuit.

7. The circuit arrangement according to claim 6, wherein the two transistors (Q1, Q2) of the differential amplifier are thermally coupled with the power transistor (M1).

8. The circuit arrangement according to claim 1, wherein the two transistors (Q1, Q2) of the differential amplifier are thermally coupled with the load (R_{L}).

9. The circuit arrangement according to claim 1, wherein the two transistors (Q1, Q2) of the differential amplifier are thermally coupled with an ambient medium selected from a group consisting of an air flow of an air-conditioning system and a cooling fluid of a cooling water circuit.

10. The circuit arrangement according to claim 1 comprising discrete components.

11. Motor vehicle fan with a circuit arrangement (2, 3) according to claim 1 wherein the load (R_{L})) is formed by a fan motor.

12. A method for the temperature-dependent regulation of a current ( I_{L}) through a load (R_{L})) by means of a voltage drop (V_{S}) across a resistance (R_{S}) through which the load current (I_{L}) flows as a control variable for the regulation of the load current (I_{L}), as well as by means of a reference voltage (V_{ref}) as a command variable for the regulation of the load current (I_{L}) wherein the control deviation (V_{ref}−V_{S}) is amplified in a differential amplifier,
characterised in that
for the regulation of the load current (I_{L}) as a function of the temperature a first and a second transistor (Q1, Q2) of the differential amplifier are operated at the same collector-emitter voltage (U_{CE1}, U_{CE2}) and at a constant ratio of the collector quiescent currents (I_{C1}, I_{C2}) being different from one.
